(19) United States
(12) Patent Application Publication
(10) Pub. No.: US 2003/0112515 A1
(43) Pub. Date: Jun. 19, 2003

(54) Diffractive optical element and method for producing the same

(76) Inventor: Masaaki Nakabayashi, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/285,469

(22) Filed: Nov. 1, 2002

(30) Foreign Application Priority Data
Dec. 13, 2001 (JP) 379984/2001
Oct. 17, 2002 (JP) 302913/2002

(51) Int. Cl. G02B 5/18

(52) U.S. Cl. 359/571; 359/566

(57) ABSTRACT

A diffractive optical element includes a blazed diffraction grating having inclined facets and vertical facets arrayed in an alternating sequence, in which only the vertical facets of the blazed diffraction grating are frosted by ashing. Another diffractive optical element includes a blazed diffraction grating having inclined facets and vertical facets arrayed in an alternating sequence, in which only the vertical facets of the blazed diffraction grating have an opaque film formed thereon.

### BACKGROUND OF THE INVENTION

1. Field of the Invention

The present invention relates to diffractive optical elements having blazed diffraction gratings and methods for producing the same. The term “blazed” means that a diffraction grating has an asymmetric profile produced by a technique whereby the ruled grooves are given a controlled shape so that they reflect as much as 80% of the incoming light into one particular order for a given wavelength. Blazed diffraction gratings are described, for example, in U.S. Pat. Nos. 4,011,009; 4,148,549; 4,560,249; and 5,173,599.

2. Description of the Related Art

Hitherto, certain methods using a combination of plural optical elements comprising glass materials exhibiting different dispersions are known in the art as methods for achromatizing optical systems. Alternatively, SPIE Proceedings Vol. 1354, pp. 24-37 discloses techniques for achromatism using diffractive optical elements. In general, blazed diffraction gratings each having an asymmetric profile in their ridges and grooves structure and having inclined facets and vertical facets arrayed in an alternating sequence are used in such diffractive optical elements.

The performance of diffractive optical elements depends on optical properties of materials constituting the elements and the shapes of gratings. To use these diffractive optical elements in cameras and other optical apparatus and to utilize the performance thereof sufficiently, the heights of ridges (grating height) in the diffraction grating must be increased to some extent.

However, if the heights of ridges are increased in blazed diffraction gratings, the area of incidence planes that are not necessary for light coming into the optical apparatus, namely the area of vertical facets, is increased. The light coming into the vertical facets of the diffraction gratings appears as a flare on their imaging surfaces, thus markedly deteriorating image quality. A possible solution to reduce such a flare is decreasing the heights of the protrusions in the diffraction gratings by improving optical materials, but this improvement is disappointing under these circumstances. An attempt has been made to minimize the adverse effects on effective light by forming a diffractive element on a sphere. However, even this technique is insufficient as a countermeasure for oblique incident light that is inevitable in general shooting.

### SUMMARY OF THE INVENTION

It is an object of the present invention to solve the above problems of the conventional technologies and to provide a high-performance diffractive optical element that can minimize flaring.

Another object of the present invention is to provide a method for producing a high-performance diffractive optical element that can minimize flaring at low cost.

To achieve the above objects, the present invention provides, in a first aspect, a diffractive optical element including a blazed diffraction grating having inclined facets and vertical facets arrayed in an alternating sequence, in which only the vertical facets of the blazed diffraction grating are frosted by ashing.

The present invention also provides, in a second aspect, a diffractive optical element including a blazed diffraction grating having inclined facets and vertical facets arrayed in an alternating sequence, in which only the vertical facets of the blazed diffraction grating have an opaque film formed thereon.

The diffractive optical elements according to the first and second aspects of the present invention may each include a substrate, and a resin layer formed on the substrate, the resin layer having ridges and grooves on its surface, the ridges and grooves including the inclined facets and vertical facets. It is preferred that only the inclined facets of the blazed diffraction gratings have an antireflection coating formed thereon. A multi-layer diffractive optical element can be formed by bonding two pieces of the diffractive optical element, according to the first or second aspect, to each other so that the diffraction gratings face each other.

The diffractive optical element according to the first aspect can be produced by a method including the steps of forming a resin layer on a substrate, the resin layer including a blazed diffraction grating on its surface, the blazed diffraction grating having inclined facets and vertical facets arrayed in an alternating sequence; forming an antireflection coating only on the inclined facets of the blazed diffraction grating; and ashing the blazed diffraction grating to thereby frost only the vertical facets of the blazed diffraction grating.

The diffractive optical element according to the second aspect can be produced by a method including the steps of forming a resin layer on a substrate, the resin layer having a blazed diffraction grating on its surface, the blazed diffraction grating having inclined facets and vertical facets arrayed in an alternating sequence; applying an opaque film to the inclined facets and the vertical facets of the blazed diffraction grating by dipping; and removing only the opaque film on the inclined facets by anisotropic etching of the blazed diffraction grating.

The method for producing the diffractive optical element according to the second aspect may further include the step of forming an antireflection coating only on the inclined facets of the blazed diffraction grating. Such an antireflection coating is formed, for example, by vapor deposition.

In the methods for producing the diffractive optical elements according to the first and second aspects, the step of forming a resin layer may, for example, include the steps of supplying an ultraviolet curable resin onto a mold having a diffraction grating pattern formed thereon; overlaying a substrate on the ultraviolet curable resin; applying ultraviolet rays to the ultraviolet curable resin to thereby cure the resin; and removing the cured resin and the substrate from the mold.

Further objects, features and advantages of the present invention will become apparent from the following description of the preferred embodiments with reference to the attached drawings.

### BRIEF DESCRIPTION OF THE DRAWINGS

FIG. 1 is a schematic sectional view of a diffractive optical element according to a first embodiment of the present invention.

FIG. 2 is a schematic sectional view of a first optical member before bonding, which constitutes the diffractive optical element shown in FIG. 1.

FIG. 3 is a schematic sectional view of a second optical member before bonding, which constitutes the diffractive optical element shown in FIG. 1.

FIGS. 4A to 4D are schematic sectional views illustrating a method for preparing the first optical member shown in FIG. 2.

FIGS. 5A and 5B are schematic sectional views illustrating a method for preparing the first optical member shown in FIG. 2.

FIGS. 6A to 6C are schematic sectional views illustrating a method for preparing a first optical member according to a second embodiment of the present invention.

FIG. 7 is a schematic diagram illustrating surface treatment of a diffraction grating by reactive ion beam etching.

### DESCRIPTION OF THE PREFERRED EMBODIMENTS

First Embodiment

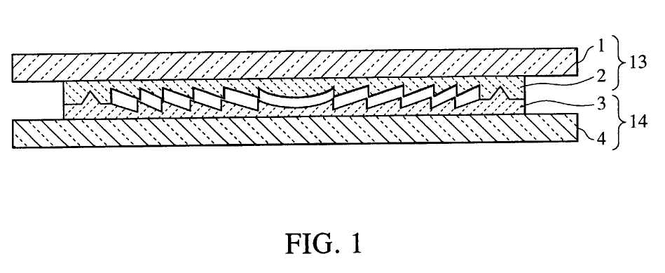

FIG. 1 shows a diffractive optical element according to the first embodiment of the present invention, by taking a multi-layer diffractive optical element as an example. The diffractive optical element is formed by bonding a first optical member 13 and a second optical member 14. The first optical member 13 comprises a first substrate 1 and a first resin layer 2 formed on the first substrate 1. The first resin layer 2 comprises a first blazed diffraction grating formed on its surface. The second optical member 14 comprises a second substrate 4 and a second resin layer 3 formed on the second substrate 4. The second resin layer 3 comprises a second blazed diffraction grating formed on its surface. The first and second optical members 13 and 14 are bonded to each other using an adhesive (not shown) so that the first and second resin layers face each other.

In the diffractive optical element of FIG. 1, the first substrate 1 and the second substrate 4 are made of glass. The first resin layer 2 is made from a photo-curable resin mainly containing a modified urethane acrylate with a high refractive index and high dispersion. The second resin layer 3 is made from an acrylate ultraviolet curable resin with low dispersion. Materials for these resin layers can be arbitrarily selected as an optimum combination by means of optical design according to the target application. The order of overlaying the components can also be arbitrarily selected. Table 1 shows materials and optical properties of the resin layers.

TABLE 1

| | | Refractive | |
|---|---|---|---|
| | | index after | Abbe |
| | Material | curing | number |
| First resin | Modified urethane acrylate UV | 1.635 | 23.0 |
| layer | curable resin | | |
| Second resin | Urethane-modified polyester | 1.525 | 50.8 |
| layer | acrylate UV curable resin | | |

When a diffractive optical element is used in cameras and other optical apparatus, the diffraction grating must be formed in such a form as to converge the rays in a used wavelength region to a specific order. In the present embodiment, the shapes of the gratings in the individual resin layers are determined so as to the multi-layer diffractive optical element can have a high diffraction efficiency in the c-line wavelength (565.27 nm) and the g-line wavelength (435.83 nm). The blazed diffraction grating formed in the first resin layer 2 has a grating height of 6.74 μm, and the blazed diffraction grating formed in the second resin layer 3 has a grating height of 9.50 μm. These blazed diffraction gratings are configured so as to act as a lens with respect to incident light. The grating pitch therefore decreases with an increasing distance from the center of the diffraction gratings to the minimum pitch of about 40 μm or less. The two blazed diffraction gratings have the same grating pitch.

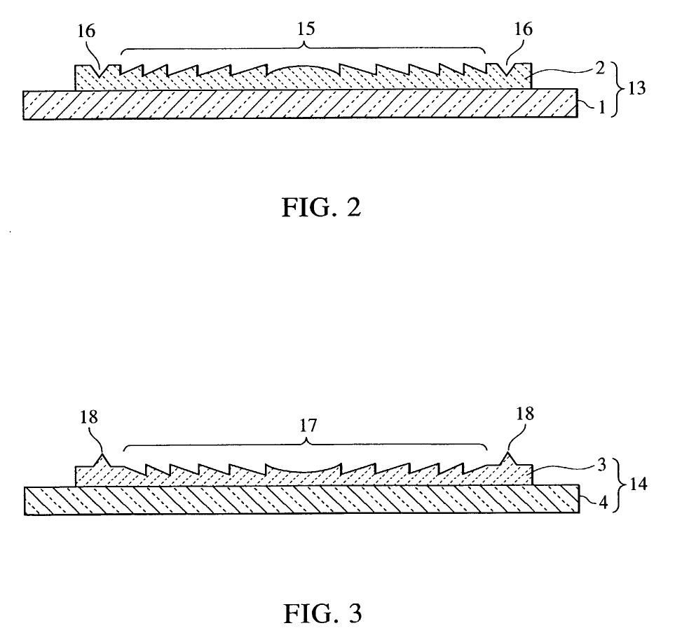

FIGS. 2 and 3 are schematic sectional views illustrating a first optical member and a second optical member, respectively, before bonding to produce the diffractive optical element. In FIGS. 2 and 3, the same members as those in FIG. 1 have the same numerical references, and detailed descriptions thereof will be omitted.

With reference to FIG. 2, a blazed diffraction grating 15 is formed on the surface of the first resin layer 2. An annular depression 16 is formed on the rim of the blazed diffraction grating 15. With reference to FIG. 3, a blazed diffraction grating 17 is formed on the surface of the second resin layer 3. An annular protrusion 18 is formed on the rim of the blazed diffraction grating 17. When the first optical member 13 and the second optical member 14 are bonded to each other, the depression 16 is engaged with the protrusion 18 for registration. The positions of the depression 16 and the protrusion 18 are equal to each other, with errors of 1 μm or less, with respect to the centers of the respective optical members.

Each of the first and second optical members shown in FIGS. 2 and 3 can also be used alone as a single-layer diffractive optical element.

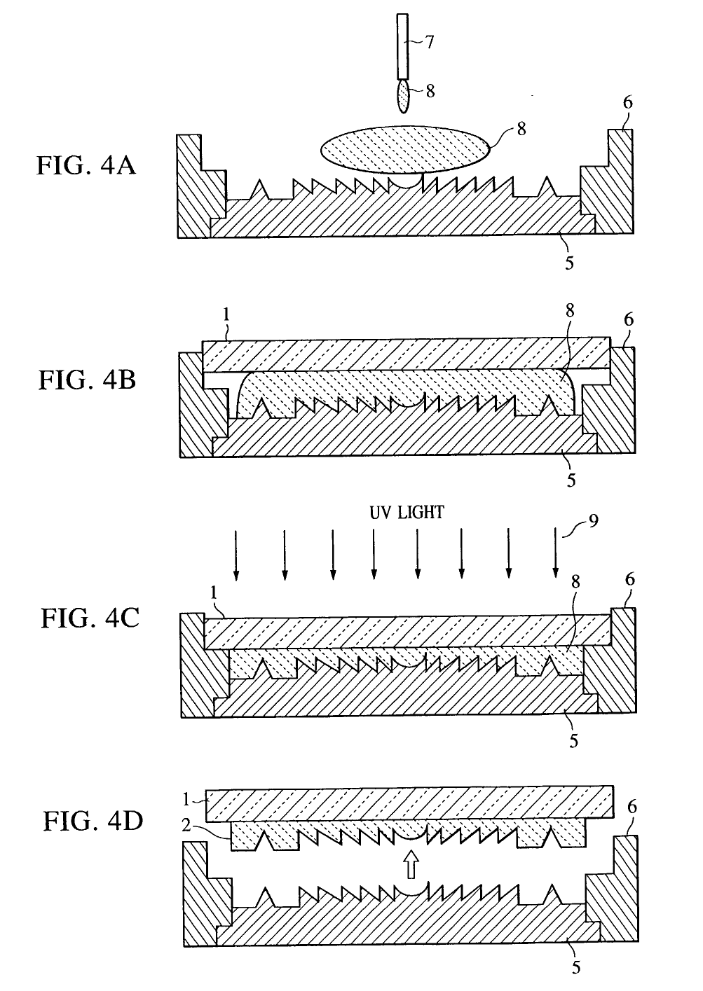

A method for producing the first optical member 13 of FIG. 2 will be illustrated with reference to the schematic sectional views of FIGS. 4A to 4D. Initially, a mold 5 shown in FIG. 4A is prepared. The mold 5 is formed by plating steel with chromium and has a ridges and grooves pattern on its surface. The ridges and grooves pattern is in the reversed form of a ridges and grooves pattern to be formed on the first resin layer 2. The shape of the ridges and grooves pattern is designed by computation and is formed by cutting the surface of the mold with a cutting tool.

The mold 5 is fastened to a mold holder 6, and an ultraviolet (UV) curable resin 8 is dropped onto the mold 5 using a dispenser 7 from above. After the resin 8 spreads to a region of the mold 5 where the ridges and grooves pattern is formed, the mold 5 having the resin 8 is preferably subjected to defoaming by reducing the pressure in a vacuum chamber to about 10 mmHg. This is because such a micro grating having a grating pitch of 40 μm and a grating height of nearly 10 μm may contain air inside thereof when a resin spreads on a mold, leading to dimensional defects. The defoaming procedure can remove the air inside of the mold and can thereby prevent dimensional defects of the resulting molded article.

Next, the first substrate 1 made of glass is prepared. To increase adhesion to the resin, the first substrate 1 has been coated with a silane coupling agent on its surface using a spinner and has been dried. A very small amount of the resin is dropped onto the center of the first substrate 1, the resin drop and the resin 8 on the mold 5 are brought into contact with each other at first, and the first substrate 1 is slowly moved down and is fixed at a desired position as shown in FIG. 4B.

With reference to FIG. 4C, ultraviolet rays 9 are then applied to the UV curable resin 8 through the first substrate 1 using a lamp (not shown) to thereby cure the resin 8.

After the UV curable resin 8 is cured, external forces are applied to the first substrate 1 to thereby remove the cured resin from the mold 5 as shown in FIG. 4D. The removed resin will constitute the first resin layer 2.

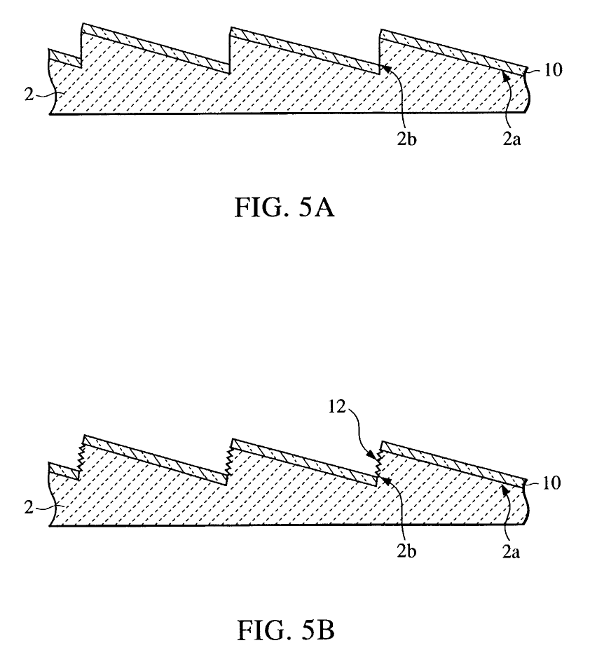

Next, the first optical member prepared by the method shown in FIGS. 4A to 4D is brought into a vacuum deposition chamber, and an antireflection coating (reflection reducing optical coating) is formed on the first optical member by vacuum deposition. FIG. 5A shows the first optical member having the antireflection coating formed thereon.

FIG. 5A is a magnified schematic sectional view of a part of the first resin layer 2 of the fist optical member. A blazed diffraction grating is formed on the surface of the first resin layer 2. The blazed diffraction grating comprises inclined facets (first grating facets) 2a and vertical facets (second grating facets) 2b arrayed in an alternating sequence. The inclined facets 2a form a relatively small angle with respect to the surface of the substrate not shown. In contrast, the vertical facets 2b are normal to the substrate surface or form a larger angle with respect to the substrate surface than that of the first inclined facets 2a.

When the blazed diffraction grating is subjected to vacuum deposition with the substrate surface facing a vacuum deposition source, an antireflection coating 10 is formed on the inclined facets 2a but is not formed on the vertical facets 2b. This is because the vertical facets 2b are substantially parallel to the direction of vacuum deposition particles flown from the vacuum deposition source. In addition, the antireflection coating 10 is also formed on the tips of the grating in the protrusion formed by a wraparound, and the protrusions on the tips of the grating protect the vertical facets 2b with respect to the vacuum deposition particles to thereby prevent the formation of the antireflection coating on the vertical facets 2b.

Next, the first optical member having the antireflection coating formed thereon is brought into a counter electrode type ashing device and is subjected to ashing with oxygen. FIG. 5B is a magnified schematic sectional view of a part of the surface of the ashed first resin layer 2. In FIG. 5B, the same members as those in FIG. 5A have the same reference numerals, and a detailed description thereof will be omitted.

With reference to FIG. 5B, only the vertical facets 2b are ashed, since the resin surface of the vertical facets 2b is not covered while the inclined facets 2a are coated with the antireflection coating 10. The ashing treatment roughens the surfaces of the vertical facets 2b, and the vertical facets 2b are thereby frosted. The counter electrode type ashing device used in the present embodiment is excellent in ashing speed and uniformity. To prevent deterioration in the antireflection coating 10 during ashing, it is preferred that the oxygen pressure is relatively high and the radio frequency (RF) output is relatively low. For example, ashing is preferably performed at an oxygen pressure from about 20 to about 50 Pa with a RF output from about 20 to about 100 W.

Thus, the first optical member 13 shown in FIG. 2 is prepared. Likewise, the second optical member 14 shown in FIG. 3 is prepared in the same manner as in FIGS. 4A to 4D and FIGS. 5A and 5B.

One of the first and second optical members 13 and 14 thus prepared is fixed to a fixture, and a thixotropic photo-curable adhesive having low fluidity is dropped outside the depression 16 or protrusion 18 shown in FIG. 2 or 3 at plural points in the circumferential direction. Next, the other optical member is overlaid thereon so that the surfaces having the blazed diffraction gratings face each other and the centers of the two members approximately coincide with each other. In this procedure, interference fringes are formed in regions where the blazed diffraction gratings are formed, and it is also acceptable to roughly adjust the positions of the two members to make the centers coincide with each other using the interference fringes as an index. The two optical members are integrated so that the depression 16 and protrusion 18 formed on their rims are engaged with each other, and ultraviolet rays are applied thereto to cure the adhesive. Thus, the multi-layer diffractive optical element shown in FIG. 1 is produced.

Second Embodiment

A diffractive optical element according to the second embodiment of the present invention will be illustrated below. The diffractive optical element according to the second embodiment has a similar appearance to that of the diffractive optical element of FIG. 1, except that an opaque film is formed on vertical facets instead of frosting by ashing. The first and second optical members constituting the diffractive optical element according to the second embodiment have the same appearance as the first and second optical members shown in FIGS. 2 and 3.

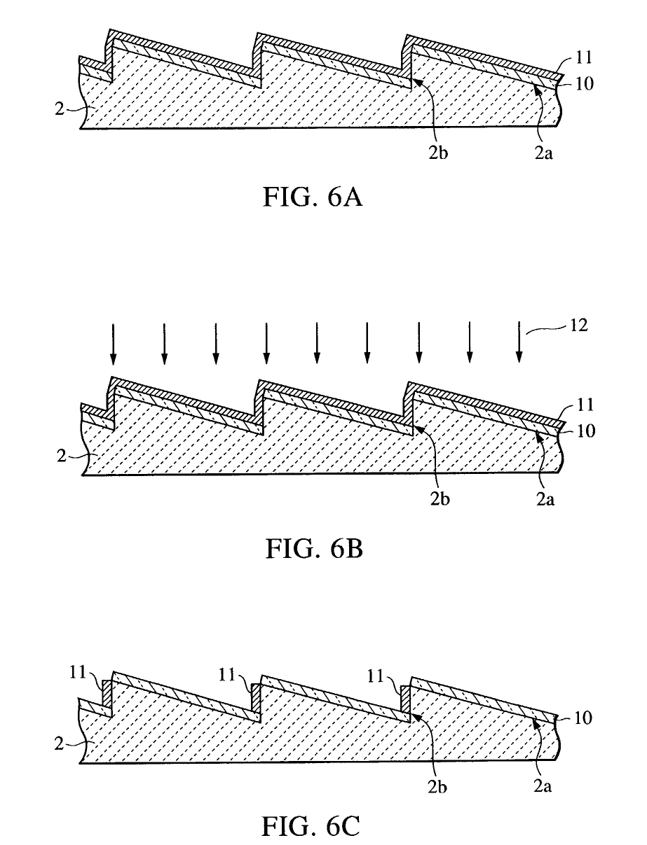

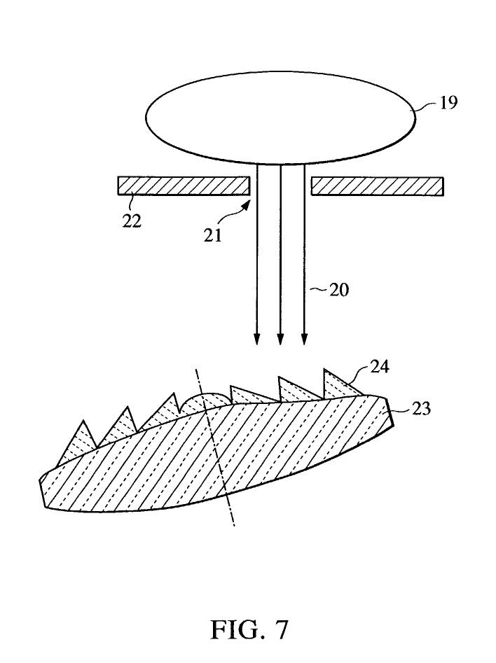

A method for preparing the fist optical member according to the second embodiment will be illustrated with reference to the schematic sectional views of FIGS. 6A to 6C. FIGS. 6A to 6C are magnified schematic sectional views of a part of a first resin layer of the first optical member. In FIGS. 6A to 6C, the same members as those in FIG. 5A have the same reference numerals, and a detailed description thereof will be omitted.

Initially, the first optical member having a blazed diffraction grating with an antireflection coating formed thereon is prepared in the same manner as in the first embodiment illustrated in FIGS. 4A to 4D and FIG. 5A. Next, with reference to FIG. 6A, an opaque film 11 is applied onto the entire blazed diffraction grating by dipping. The opaque film 11 is made from a pigment coating sufficiently diluted with a diluent and is capable of light-shielding and frosting. If the diluent has an excessively high boiling point, flow marks are formed due to the shape of the diffraction grating when the grating is raised in the dipping procedure. It is therefore important to control the temperature of the diluted coating and the temperature of the grating. The first optical member having the opaque film 11 is then dried in an oven to thereby sufficiently fix the opaque film to the resin layer.

Next, the first optical member having the opaque film 11 is brought into a parallel-plate reactive ion etch (RIE) apparatus and is etched by the application of ions 12 as show in FIG. 6B. With reference to FIG. 6B, the opaque film on the inclined facets 2a is removed by etching and remains only on the vertical facets 2b, as shown in FIG. 6C. This is because the reactive ion etching is highly anisotropic, and ions are hardly applied to the vertical facets having fine ridges and grooves on the order of micrometers. To etch the optical member, CF₄ or CHF₃ is supplied as a reaction gas into the apparatus at a pressure of 10 to 100 Pa and radio frequency output is applied to generate plasma. The etching time is calculated based on the thickness of opaque film and the etching rate. In the present embodiment, the removal of the opaque film by etching is completed within about 1 minute.

The first optical member of the diffractive optical element according to the second embodiment is prepared in the above manner. The second optical member can be prepared in the same manner as illustrated in FIGS. 6A to 6C. By bonding these optical members in the same manner as in the first embodiment, a multi-layer diffractive optical element similar to that in FIG. 1 is produced.

When the ridges and grooves of the blazed diffraction gratings in the second embodiment have a greater height, namely, when the grating height is greater, reactive ion beam etching (RIBE) having higher ion directivity is preferably used.

In producing an optical element having a convex lenticular diffraction grating formed on a convex sphere or one having a concave lenticular diffraction grating formed on a concave sphere by reactive ion beam etching, the angle formed between the vertical facets and the ion beam varies by location. In this case, the overall optical element must be anisotropically etched in the plane-normal direction. This can be achieved, for example, by the following procedure shown in FIG. 7.

FIG. 7 is a schematic view illustrating a surface treatment of the diffraction grating by reactive ion beam etching (RIBE). A masking shield 22 having an aperture 21 restricts the ion illumination area of an ion beam 20 emitted from a plasma source 19. A resin layer 24 having a blazed diffraction grating is formed on a convex lenticular substrate 23. The substrate 23 is allowed to rotate with a varying angle so that the plane normal of the diffractive optical element always coincide with the direction of ion illumination. Thus, the overall optical element can be etched with desired anisotropy. In this technique, the ion beam is controlled to form a predetermined angle with respect to the curved surface of the substrate.

The antireflection coating often has a silicon oxide layer as the outermost layer. In this case, the outermost layer would be etched by RIE or RIBE, and it is important to set the end point in advance to avoid etching of the outermost layer.

While the present invention has been described with reference to what are presently considered to be the preferred embodiments, it is to be understood that the invention is not limited to the disclosed embodiments. For example, the embodiments are illustrated by taking multi-layer diffractive optical elements as an example, but the present invention can also be applied to the cases where each of the optical members shown in FIGS. 2 and 3 is used alone as a single-layer diffractive optical element.

The invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A diffractive optical element comprising:
a blazed diffraction grating having inclined facets and vertical facets arrayed in an alternating sequence,
wherein only the vertical facets of the blazed diffraction grating are frosted by ashing.

2. The diffractive optical element according to claim 1, further comprising:
a substrate; and
a resin layer formed on the substrate, the resin layer having ridges and grooves on its surface,
wherein the ridges and grooves are the inclined facets and the vertical facets.

3. The diffractive optical element according to claim 1, wherein only the inclined facets of the blazed diffraction grating have an antireflection coating formed thereon.

4. A diffractive optical element comprising:
a first optical member comprising:
a first substrate; and
a first resin layer formed on the first substrate, the first resin layer comprising a first blazed diffraction grating on its surface, the first blazed diffraction grating having inclined facets and vertical facets arrayed in an alternating sequence; and
a second optical member comprising:
a second substrate; and
a second resin layer formed on the second substrate, the second resin layer comprising a second blazed diffraction grating on its surface, the second blazed diffraction grating having inclined facets and vertical facets arrayed in an alternating sequence,
wherein the first and second optical members are bonded to each other so that the first and second resin layers face each other, and
wherein only the vertical facets of the first and second blazed diffraction gratings are frosted by ashing.

5. The diffractive optical element according to claim 4, wherein only the inclined facets of the first and second blazed diffraction gratings have an antireflection coating formed thereon.

6. A method for producing a diffractive optical element comprising the steps of:
forming a resin layer on a substrate, the resin layer comprising a blazed diffraction grating on its surface, the blazed diffraction grating having inclined facets and vertical facets arrayed in an alternating sequence;
forming an antireflection coating only on the inclined facets; and
ashing the blazed diffraction grating to thereby frost only the vertical facets of the blazed diffraction grating.

7. The method according to claim 6, further comprising forming the antireflection coating by vapor deposition.

8. The method according to claim 6, wherein the step of forming the resin layer comprises the steps of:
supplying an ultraviolet curable resin onto a mold having a diffraction grating pattern formed thereon;
overlaying a substrate on the ultraviolet curable resin;
applying ultraviolet rays to the ultraviolet curable resin to thereby cure the resin; and
removing the cured resin and the substrate from the mold.

9. A diffractive optical element comprising:
a blazed diffraction grating having inclined facets and vertical facets arrayed in an alternating sequence,
wherein only the vertical facets of the blazed diffraction grating have an opaque film formed thereon.

10. The diffractive optical element according to claim 9, further comprising:
a substrate; and
a resin layer formed on the substrate, the resin layer having ridges and grooves on its surface,
wherein the ridges and grooves are the inclined facets and the vertical facet.

11. The diffractive optical element according to claim 9, wherein only the inclined facets of the blazed diffraction grating have an antireflection coating formed thereon.

12. A diffractive optical element comprising:
a first optical member comprising:
a first substrate; and
a first resin layer formed on the first substrate, the first resin layer comprising a first blazed diffraction grating on its surface, the first blazed diffraction grating having inclined facets and vertical facets arrayed in an alternating sequence; and
a second optical member comprising:
a second substrate; and
a second resin layer formed on the second substrate, the second resin layer comprising a second blazed diffraction grating on its surface, the second blazed diffraction grating having inclined facets and vertical facets arrayed in an alternating sequence,
wherein the first and second optical members are bonded to each other so that the first and second resin layers face each other; and
wherein only the vertical facets of the first and second blazed diffraction gratings have an opaque film formed thereon.

13. The diffractive optical element according to claim 12, wherein only the inclined facets of the first and second blazed diffraction gratings have an antireflection coating formed thereon.

14. A method for producing a diffractive optical element, comprising the steps of:
forming a resin layer on a substrate, the resin layer comprising a blazed diffraction grating on its surface, the blazed diffraction grating having inclined facets and vertical facets arrayed in an alternating sequence;
applying an opaque film to the inclined facets and the vertical facets of the blazed diffraction grating by dipping; and
removing only the opaque film on the inclined facets by anisotropic etching of the blazed diffraction grating.

15. The method according to claim 14, wherein the anisotropic etching is a reactive ion beam etching.

16. The method according to claim 15, further comprising:
forming the resin layer on a curved surface of the substrate; and
controlling the ion beam to form a set angle with respect to the curved surface during etching.

17. The method according to claim 14, further comprising the step of forming an antireflection coating only on the inclined facets of the blazed diffraction grating.

18. The method according to claim 17, further comprising forming the antireflection coating by vapor deposition.

19. The method according to claim 14, wherein the step of forming the resin layer comprises the steps of:
supplying an ultraviolet curable resin onto a mold having a diffraction grating pattern formed thereon;
overlaying a substrate on the ultraviolet curable resin;
applying ultraviolet rays to the ultraviolet curable resin to thereby cure the resin; and
removing the cured resin and the substrate from the mold.
